(19) United States
(12) Patent Application Publication
(10) Pub. No.: US 2021/0269166 A1
(43) Pub. Date: Sep. 2, 2021

(54) LOCKING ASSEMBLY AND MOVABLE PLATFORM

(71) Applicant: SZ DJI TECHNOLOGY CO., LTD., Shenzhen (CN)

(72) Inventors: Deyang MA, Shenzhen (CN); Shijing GAO, Shenzhen (CN)

(73) Assignee: SZ DJI TECHNOLOGY CO., LTD., Shenzhen (CN)

(21) Appl. No.: 17/199,482

(22) Filed: Mar. 12, 2021

Related U.S. Application Data
(63) Continuation of application No. PCT/CN2020/077506, filed on Mar. 2, 2020.

(51) Int. Cl. B64D 27/24; B64C 39/02

(52) U.S. Cl. CPC B64D 27/24; B64C 2201/042; B64C 39/024

(57) ABSTRACT

The present disclosure relates to a locking assembly for locking at least one second body to a first body. The first body may have at least one accommodating cavity for accommodating the at least one second body respectively. The locking assembly may include a knob on the first body and a pushing device between the knob and the first body. The knob may be configured to rotate around an axis to switch the locking assembly between a locked state and an unlocked state. The pushing device may be configured to apply an elastic pressing force on the knob in a direction away from the first body during rotation of the knob.

### CROSS-REFERENCE TO RELATED APPLICATION

The present application is a continuation of International Application No. PCT/CN2020/077506, filed on Mar. 2, 2020, the entire contents of which being incorporated herein by reference in its entirety.

### TECHNICAL FIELD

The present disclosure relates to technical field of mechanical structures, in particular, to a locking assembly and a movable platform.

### BACKGROUND

Unmanned aerial vehicles (UAV) have been widely used in agriculture, surveying, security, detection and other fields. Due to their own operational characteristics, safety performance of the unmanned aerial vehicles has been subjected to strict requirement. Improving flight safety and structural reliability of the unmanned aerial vehicles are key points in the design of the unmanned aerial vehicles.

During flight of an unmanned aerial vehicle, electric energy is generally provided by a battery. A battery locking structure, as a protection structure for the battery of the unmanned aerial vehicle, is needed to ensure that the battery functions normally during the flight. Furthermore, the battery locking structure needs have characteristics of reliable locking and convenient operation. Current battery lock structures in the field of unmanned aerial vehicles have relatively complicated structures.

### SUMMARY

One embodiment of the present disclosure provides a locking assembly for locking at least one second body to a first body. The first body has at least one accommodating cavity for accommodating the at least one second body respectively. The locking assembly may include a knob on the first body and a pushing device between the knob and the first body. The knob is configured to rotate around an axis to switch the locking assembly between a locked state and an unlocked state; and the pushing device is configured to apply an elastic pressing force on the knob in a direction away from the first body during rotation of the knob.

Optionally, in a process of switching from the locked state to the unlocked state, the knob rotates to drive the pushing device to move in a direction toward the first body, and the elastic pressing force applied by the pushing device on the knob increases.

Optionally, in a process of switching from the unlocked state to the locked state, the pushing device moves in a direction away from the first body, and the elastic pressing force applied by the pushing device on the knob decreases.

Optionally, the pushing device comprises a guiding surface, the knob comprises a mating surface, and the guiding surface is configured to cooperate with the mating surface to drive the pushing device to move during the rotation of the knob.

Optionally, the guiding surface is an arc surface or an inclined surface.

Optionally, the pushing device has a first contact surface and a second contact surface, and the guiding surface is connected between the first contact surface and the second contact surface. In the unlocked state, a lower surface of the knob is in contact with the first contact surface, and in the locked state, the lower surface of the knob is in contact with the second contact surface. The first contact surface is higher than the second contact surface.

Optionally, the pushing device comprises a floating block and an elastic member, the floating block is configured to push the knob, and the elastic member is between the floating block and the first body, in a process of switching from the locked state to the unlocked state, the elastic member is gradually compressed; and in a process of switching from the unlocked state to the locked state, the elastic member gradually recovers from compressed deformation.

Optionally, the knob and the pushing device are coaxially connected by a connecting shaft.

Optionally, one end of the connecting shaft passes through the knob and the pushing device to be fixedly connected to the first body, and the other end of the connecting shaft is provided with an axial limiting member for axially limiting positions of the knob and the pushing device.

Optionally, there are at least two second bodies.

Optionally, the knob comprises at least two support arms, the number of the support arms is equal to the number of the second bodies, and one of the support arms presses against one of the second bodies correspondingly.

Optionally, the at least two second bodies are evenly arranged around the knob, and an included angle between every two adjacent second bodies is approximately equal to an included angle between every two adjacent support arms of the knob.

Optionally, the pushing device comprises an inserting post for inserting into the first body.

Optionally, the locking assembly further comprises an in-position detection device in the first body, wherein the in-position detection device is configured to detect an end position of the inserting post in the first body, thereby determining the state of the locking assembly.

Optionally, the first body is a body of a movable platform, and the second body is a battery.

Optionally, the movable platform is an unmanned aerial vehicle.

Another embodiment of the present disclosure relates to a locking assembly for locking at least one second body on a first body. The first body has at least one accommodating cavity for accommodating the at least one second body respectively. The locking assembly may include a detachable member detachably fixed with the first body and a knob provided on the first body through the detachable member. The knob is capable of rotating around an axis relative to the first body. The knob is configured to rotate to switch the locking assembly between a locked state and an unlocked state, in the locked state, the knob pushes and fixes the at least one second body in the at least one accommodating cavity respectively, and in the unlocked state, the knob avoids the at least one second body.

Optionally, the locking assembly further includes a pushing device movably arranged between the knob and the detachable member, wherein the pushing device is configured to apply an elastic pressing force on the knob in a direction away from the first body during rotation of the knob.

Optionally, in a process of switching from the locked state to the unlocked state, the knob rotates to drive the pushing device to move in a direction toward the first body, and the elastic pressing force applied by the pushing device on the knob gradually increases.

Another embodiment of the present disclosure is a movable platform, comprising a body, at least one battery, and a locking assembly for locking the at least one battery on the body. The body has at least one accommodating cavity for accommodating the at least one battery respectively. The locking assembly includes a knob on the body and a pushing device movably arranged between the knob and the body. The knob is capable of rotating around an axis relative to the body. The pushing device is configured to apply an elastic pressing force on the knob in a direction away from the body during rotation of the knob; and the knob is configured to rotate to switch the locking assembly between a locked state and an unlocked state. In the locked state, the knob pushes and fixes the at least one battery in the at least one accommodating cavity respectively, and in the unlocked state, the knob avoids the at least one battery.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a locking assembly in an unlocked state provided by an embodiment of the present disclosure;

FIG. 2 is a schematic diagram of a locking assembly in a locked state provided by an embodiment of the present disclosure;

FIG. 3 is a schematic diagram of a mating state of a locking assembly with a first body in an unlocked state provided by an embodiment of the present disclosure;

FIG. 4 is an enlarged view of A in FIG. 3;

FIG. 5 is a schematic diagram of a body and batteries of a movable platform in an unlocked state provided by an embodiment of the present disclosure;

FIG. 6 is a schematic diagram of a body and batteries of a movable platform in a locked state provided by an embodiment of the present disclosure;

FIG. 7 is an exploded schematic diagram of a body, a battery, and a locking assembly of a movable platform provided by an embodiment of the present disclosure;

FIG. 8 is a schematic structural diagram of a pushing device of a locking assembly provided by an embodiment of the present disclosure;

FIG. 9 is a schematic diagram of a body and a battery of a movable platform in an unlocked state provided by an embodiment of the present disclosure; and

FIG. 10 is a schematic diagram of a body and a battery of a movable platform in a locked state provided by an embodiment of the present disclosure.

### DETAILED DESCRIPTION

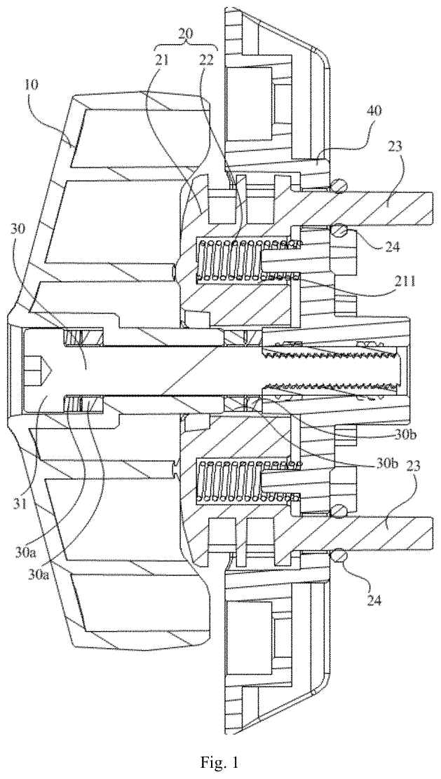

The specific embodiments of the present disclosure are further described in detail below with reference to the drawings and embodiments. The following examples are intended to illustrate the disclosure but are not intended to limit the scope of the disclosure. It should be noted that, in the case of no conflict, the features in the embodiments and the embodiments in the present application could be arbitrarily combined with each other. Throughout the description of the disclosure, reference is made to FIGS. 1-10. When referring to the figures, like structures and elements shown throughout are indicated with like reference numerals. It should be understood that the dimensions of the various parts shown in the drawings are not drawn in the actual scale. Based on these embodiments of the present disclosure, all other embodiments obtained by those of ordinary skill in the art without creative work shall fall within the protection scope of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

Unless otherwise defined, all technical and scientific terms used herein have the same meaning as commonly understood by those of ordinary skill in the technical field of the present disclosure. The terms used in the specification of the present disclosure herein are only for the purpose of describing specific embodiments, and are not intended to limit the present disclosure.

The term “comprising” mentioned in the entire specification and claims is an open term, so it should be interpreted as “including but not limited to”. “Approximately” means that within an acceptable error range, those of ordinary skill in the art can solve the technical problem and basically achieve the technical effect within a certain error range.

In addition, the term “connected” or “coupled” herein includes any direct or indirect means of connection. Therefore, if it is described that a first device is connected or coupled to a second device, it means that the first device can be directly connected or coupled to the second device, or indirectly connected or coupled to the second device through other devices.

It should be understood that the term “and/or” used in this specification describes only an association relationship of the associated objects, which indicates that there can be three relationships. For example, the term “A1 and/or B1” may indicate three scenarios, that is, A1 existing alone, A1 and B1 existing simultaneously, and B1 existing alone. In addition, the character “/” in this text generally indicates that the associated objects before and after are in an “or” relationship.

In the description of the present disclosure, the terms “center,” “horizontal,” “vertical,” “length,” “width,” “thickness,” “upper,” “lower,” “front,” “back,” “left,” “right,” “vertical,” “horizontal,” “top,” “bottom,” “inner,” “outer,” “an axial direction,” “a radial direction,” “a circumferential direction,” or the like are based on the orientation or positional relationship shown in the drawings. They are used merely for convenience of description and simplifying description of the present disclosure, but not to indicate or imply that the indicated apparatus or element must have a specific orientation, or be constructed and operated in a specific orientation, therefore cannot be construed as a limitation of the present disclosure.

In addition, the terms “first” and “second” are for illustration purposes only and are not to be construed as indicating or implying relative importance or implied reference to the quantity of indicated technical features. Thus, features defined by the terms “first” and “second” may explicitly or implicitly include one or more of the features. In the description of the present disclosure, the meaning of “plural” is two or more unless otherwise specifically and specifically defined.

In the description of the specification, references made to the term “one embodiment,” “some embodiments,” and “exemplary embodiments,” “example,” and “specific example,” or “some examples” and the like are intended to refer that specific features and structures, materials or characteristics described in connection with the embodiment or example that are included in at least some embodiments or example of the present disclosure. The schematic expression of the terms does not necessarily refer to the same embodiment or example. Moreover, the specific features, structures, materials or characteristics described may be included in any suitable manner in any one or more embodiments or examples.

Through creative work, the inventors found that the battery locking structure of the unmanned aerial vehicle in the prior art has the following defects: the locking structure between the unmanned aerial vehicle and the battery is relatively complicated, and the unlocking and locking operations are inconvenient. Moreover, the locking structure in the prior art cannot be completely detached from the body of the unmanned aerial vehicle. In addition, in the prior art, the state of the battery relative to the body of the unmanned aerial vehicle cannot be accurately detected. Thus, when the battery is still in an unlocked state, the unmanned aerial vehicle may take off, thereby causing risk of an accident.

In order to solve the above technical problem, one embodiment of the present disclosure provides a locking assembly for locking a second body on a first body. The first body may have an accommodating cavity for accommodating the second body. The locking assembly according to embodiments of the present disclosure may achieve advantages such as simple structure, convenient operation, high safety and high reliability. In some embodiments, the locking assembly is a knob-type locking assembly, which has advantages such as simple structure, convenient operation, and a good operating feel.

In some embodiments, a modular locking assembly is provided to realize separate disassembly and assembly of the locking assembly, thereby supporting replacement of the locking assembly. In some embodiments, a technical solution which couples a locking assembly with an in-position detection device is provided so that the state of the locking assembly can be obtained through the in-position detection device, thereby knowing whether the battery is in a locked state or not. As such, the safety of the UAV is improved.

In addition, some embodiments of the present disclosure also provide three types of movable platforms. The movable platform may be an unmanned aerial vehicle. In some embodiments, the movable platform includes a knob-type locking assembly, which has advantages such as simple structure, convenient operation, and a good operating feel. In some embodiments, the movable platform includes a modular locking assembly to realize the separate disassembly and assembly of the locking assembly, thereby supporting the replacement of the locking assembly. In some embodiments, the movable platform includes a technical solution of coupling a locking assembly and an in-position detection device.

Some specific embodiments of the present disclosure are described in detail below.

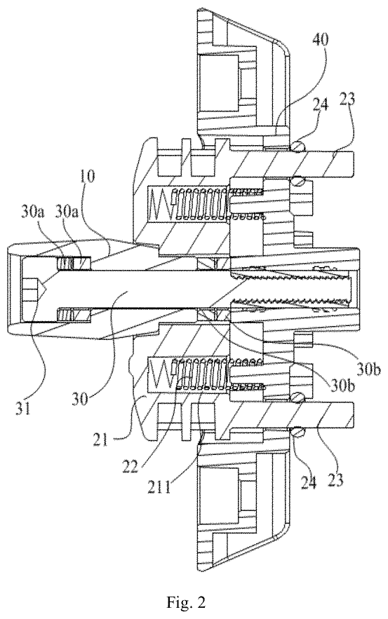

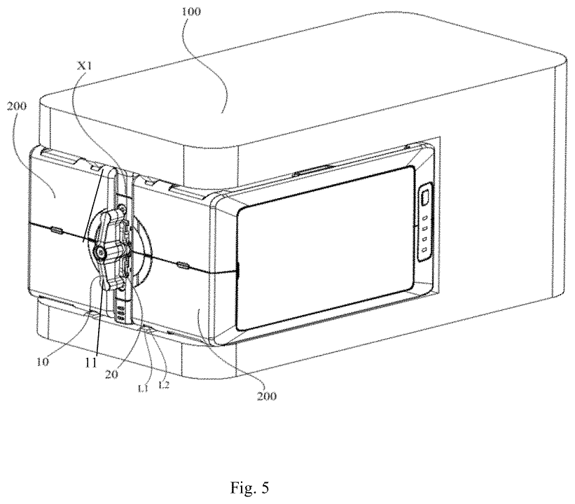

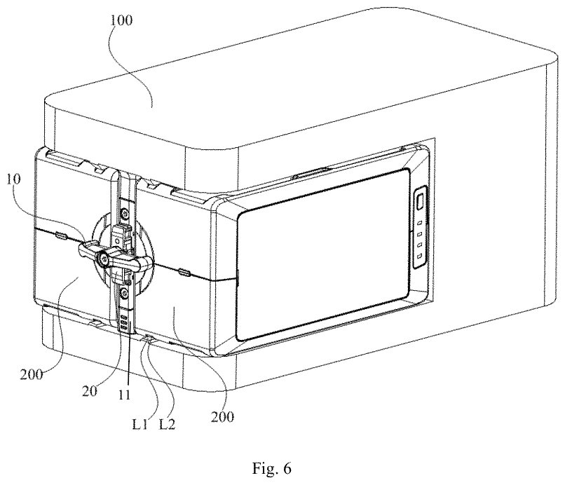

FIG. 1 is a schematic diagram of a locking assembly in an unlocked state provided by an embodiment of the present disclosure. FIG. 2 is a schematic diagram of a locking assembly in a locked state provided by an embodiment of the present disclosure. FIG. 5 is a schematic diagram of a body and batteries of a movable platform in an unlocked state provided by an embodiment of the present disclosure; FIG. 6 is a schematic diagram of a body and batteries of a movable platform in a locked state provided by an embodiment of the present disclosure. Please refer to FIGS. 1, 2, 5, and 6, one embodiment of the present disclosure provides a locking assembly for locking a second body 200 on a first body 100. The first body 100 has accommodating cavity X for accommodating the second body 200. The locking assembly provided in this embodiment can be applied to movable platforms such as unmanned aerial vehicles, electric vehicles, sweeping robots, etc. The first body 100 may be a body of the above-mentioned machine, and the second body 200 may be a battery for powering the machine.

The accommodating cavity X may have an opening. The second body 200 may be detached from the accommodating cavity X through the opening, and may also be inserted into the accommodating cavity X through the opening. When the second body 200 is a battery, the accommodating cavity X may also be provided with a power supply terminal for docking with the battery. The battery may have a power supply port, and the power supply port may be docked with the power supply terminal. Through the locking assembly, the docking state of the battery and the power supply terminal may be maintained to ensure stability of power supply.

The first body 100 and the second body 200 may also be two other components that need to be relatively locked, which are not particularly limited in this embodiment.

One embodiment of the present disclosure provides a locking assembly 300 having simple structure and convenient operation, which can lock the second body 200 on the first body 100. The locking assembly 300 may include: a knob 10 and a pushing device 20. The knob 10 is disposed on the first body 100, and the knob 10 can rotate around an axis relative to the first body 100. Specifically, the knob 10 may be directly disposed on the first body 100, and the knob 10 may also be indirectly disposed on the first body 100 through an intermediate connecting piece. In one embodiment, a connecting shaft may be connected to the first body 100. The knob 10 may be sleeved on the outer side of the connecting shaft and rotate around the axis of the connecting shaft. Alternatively, the knob 10 may have a cylindrical body, and the cylindrical body is slidably fitted with a corresponding structure on the first body 100, so that the cylindrical body can be rotated. The knob 10 may be rotated around a virtual central axis of the cylindrical body.

The pushing device 20 may be movably arranged between the knob 10 and the first body 100. The pushing device 20 may move along the central rotation axis of the knob 10. The rotation of the knob 10 can drive the pushing device 20 to move. In one embodiment, a contact surface between the knob 10 and the pushing device 20 may be an inclined surface or an arc surface. When the knob 10 is rotated, the circumferential force of the knob 10 can be partially decomposed into a force along the axial direction through the decomposition action of the contact surface of the inclined or arc surface. A such, when the knob 10 is rotated, the pushing device 20 is driven to move.

The pushing device 20 may be used to apply an elastic pressing force in a direction away from the first body 100 to the knob 10 during the rotation of the knob 10. The pushing device 20 may have elasticity. When the knob 10 is rotated clockwise, the knob 10 may drive the pushing device 20 to move in the direction of the first body 100. When the knob 10 is rotated counterclockwise, the pushing device 20 may move in the direction away from the first body 100 under the action of its own elastic restoring force.

In one embodiment, the knob 10 may be axially restricted, so that the knob 10 can only rotate in the circumferential direction, and its axial position may be unchanged. Then, in the process of switching from the locked state to the unlocked state, the knob 10 is always in contact with the second body 200. During the movement of the pushing device 20, the contact surface between the knob 10 and the pushing device 20 is constantly changing so that the pushing device 20 can move.

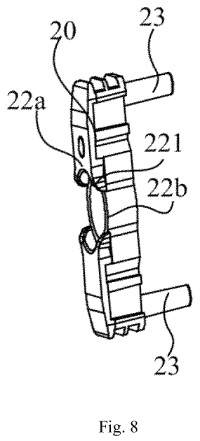

In one embodiment, no matter what angle the knob 10 rotates, the pushing device 20 may be always in contact with the knob 10, but the contact surface between the knob 10 and the pushing device 20 may change. Further, FIG. 8 is a schematic structural diagram of a pushing device of the locking assembly provided by one embodiment of the present disclosure. As shown in FIG. 8, the pushing device 20 may have a guide surface 221, and the knob 10 has a mating surface (not shown in the figure). During the rotation of the knob 10, the guide surface 221 cooperates with the mating surface to push against the pushing device 20 while the knob 10 is rotated. In one embodiment, the guiding surface 221 may be an arc surface or an inclined surface. Therefore, when the user applies a rotational torsion force to the knob 10, the external force in the circumferential direction has a component force in the axial direction so that the pushing device 20 can be pushed. The movement of the pushing device 20 may cause an elastic pressing force applied on the knob 10 by the pushing device 20 to change. The elastic member 22 of the pushing device 20 can be continuously compressed.

In one embodiment, as shown in FIGS. 5, 6 and 8, the pushing device 20 has a first contact surface 22a and a second contact surface 22b, and the guide surface 221 is connected between the first contact surface 22a and the second contact surface 22b. In the unlocked state, the lower surface of the knob 10 is in contact with the first contact surface 22a. In the locked state, the lower surface of the knob 10 is in contact with the second contact surface 22b. The first contact surface 22a is higher than the second contact surface 22b. For ease of description, the direction away from the first body 100 may be taken as the upward direction, and the direction toward the first body 100 may be taken as the downward direction.

In the process of turning from the unlocked state shown in FIG. 5 to the locked state shown in FIG. 6, the knob 10 rotates from the top end to the bottom end of the guide surface 221. In the process of turning from the locked state to the unlocked state, the knob 10 is turned from the bottom end to the top end of the guide surface 221.

In one embodiment, the pushing device 20 may have inserting posts 23 for inserting into the first body 100. During the movement of the pushing device 20, the position of the inserting post 23 in the first body 100 changes. As such, an in-position detection device for detecting the position of the inserting post 23 may be disposed in the first body 100 to determine the state of the locking assembly.

In one embodiment, the knob 10 rotates to switch the locking assembly 300 between the locked state and the unlocked state. In the locked state, the knob 10 pushes and fixes the second body 200 in the accommodating cavity X. In the unlocked state, the knob 10 avoids the second body 200. In the unlocked state, the second body 200 can be freely inserted into the accommodating cavity X or pulled out from the accommodating cavity X.

Generally, in order to improve the reliability of machine operation, the machine can be equipped with two or more batteries. As such, when a battery is exhausted or malfunctions, the machine can be powered by a backup battery. When the battery is supplying power, the battery needs to be locked by a locking assembly to ensure the stability of the electrical connection of the battery. In one embodiment, there are at least two second bodies 200. As shown in FIG. 5 and FIG. 6, taking two second bodies 200 as an example for description, the first body 100 may have two accommodating cavities X arranged side by side. Each accommodating cavity X is provided with a corresponding second body 200. The two accommodating cavities X can be separated by a middle side wall X1, and the locking assembly 300 can be arranged on the middle side wall X1. Preferably, the locking assembly 300 is disposed in the middle of the middle side wall X1 so as to ensure maximum balance of forces applied on the two second bodies 200.

In one embodiment, as shown in FIG. 6, the knob 10 may include support arms 11, which are used to press against the second bodies 200. The number of support arms 11 is equal to the number of the second bodies 200. Each support arm 11 correspondingly presses against a second body 200.

The at least two second bodies 200 may be evenly arranged, and the knob 10 may be located in the middle position enclosed by the at least two second bodies 200. The included angle between every two adjacent second bodies 200 may be equal to the included angle between every two adjacent support arms 11 of the knob. In one embodiment, for example, there are two second bodies 200 and the knob 10 has two support arms 11. The two second bodies 200 are arranged side by side, and the included angle between the two support arms 11 of the knob 10 is approximately 180°. Wherein, being approximately 180° means that a certain processing or assembly error can be allowed. For example, an included angle between two support arms 11 being in the range of 175° to 185° can be understood as being approximately 180°. That is to say, the knob 10 is roughly in a shape of a line, and the knob 10 has a centrally symmetrical structure. In this way, no matter how the knob 10 is rotated, the positions of the two support arms 11 on the two second bodies 200 are symmetrical. As such, the two second bodies 200 can be locked and unlocked simultaneously.

It can be understood that when there are more than two second bodies 200, the plurality of second bodies 200 may be evenly arranged. The included angle between every two adjacent second bodies 200 is a, and the included angle between every two adjacent support arms 11 on the knob 10 is also a. For example, if three second bodies 200 are arranged at 120° to one another, the number of support arms 11 of the knob 10 may be three, and the included angle between every two adjacent support arms 11 of the three arms is 120°. In this way, the knob 10 can also lock and unlock each second body 200 at the same time.

It can be understood that the number of the second bodies 200 and the number of the support arms 11 of the knob 10 are not limited to two or three, and other numbers are also possible.

Optionally, when the knob 10 is switched between the locked state and the unlocked state, the angle rotated by the knob 10 is approximately 90°. For example, from the unlocked state in FIG. 5 to the locked state in FIG. 6, the knob 10 is rotated from the vertical position to the horizontal position. Wherein, “approximately 90°” means that a certain processing or assembly error can be allowed, and the angle rotated by the knob 10 can be in the range of 85° to 95°. In this way, the locking stability of the knob 10 can be maximized.

In one embodiment, the two second bodies 200 are arranged in a left-right arrangement, as shown in FIGS. 5 and 6. When the knob 10 is at a vertical position, it is in an unlocked state. When the knob 10 is at a horizontal position, it is in a locked state. In another embodiment, the two second bodies 200 are arranged up and down. When the knob 10 is at a vertical position, it is in a locked state, and when the knob 10 is at a horizontal position, it is in an unlocked state.

Of course, it can be understood that taking FIGS. 5 and 6 as an example, in positions other than the unlocked state, the locking assembly 300 is in the intermediate locked state before the knob 10 reaches the horizontal position. Similarly, the second bodies 20 cannot be escaped from the accommodating cavities X.

In some embodiments, in the process of switching between the locked state and the unlocked state, the angle that the knob 10 rotates may not be limited to 90°. For example, the knob 10 is in the unlocked state when the knob 10 is in the vertical position. When the knob 10 is rotated through a small angle, the locking assembly 300 can be locked. The second body 200 can be locked by turning the knob 10 at any angle such as 30°, 45°, 60°, etc.

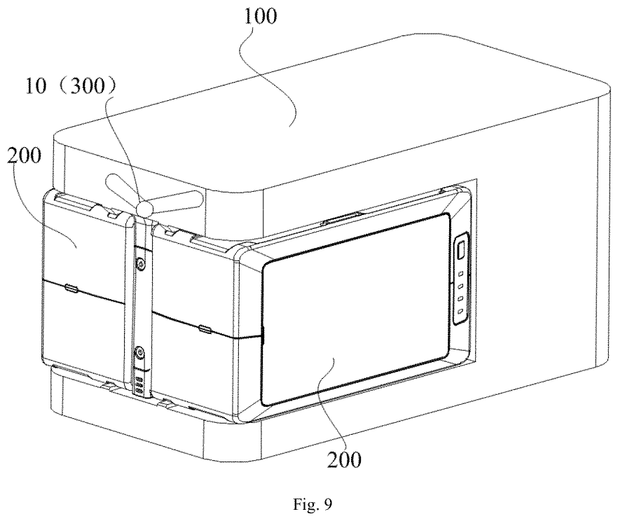

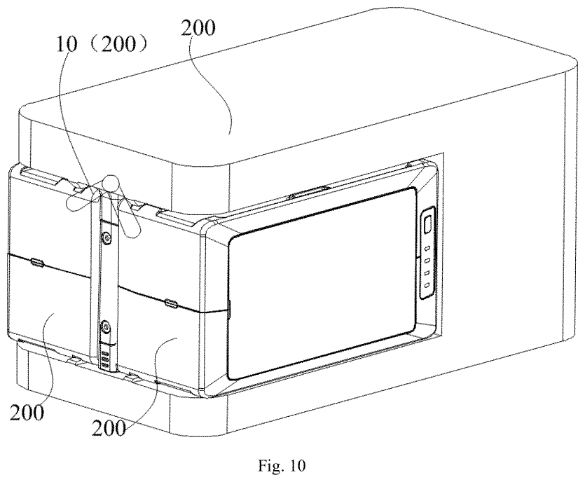

In some embodiments, FIG. 9 is a schematic diagram of a body and a battery of a movable platform in an unlocked state according to an embodiment of the present disclosure. FIG. 10 is a schematic diagram of a body and a battery of a movable platform in a locked state according to an embodiment of the present disclosure. As shown in FIG. 9, the locking assembly 300 may be arranged at the upper part of the first body 100, and the knob 10 may be in a V shape. As shown in FIG. 10, when the knob 10 is rotated by 180°, it can block the two second bodies 200 from coming out of the accommodating cavity X, thereby fixing the second bodies 200 in the accommodating cavities X. Of course, in other embodiments, the locking assembly 300 may also be provided at the lower part of the first body 100.

In addition, the length of the arm 11 of the knob 10 can be as long as possible, so that a larger torque can be output to overcome the elastic pressing force of the pressing device 20. As such, the unlocking and locking operation may be labor-saving.

The locking assembly provided by some embodiments of the present disclosure is used to lock the second body on the first body, and the locked state or the unlocked state of the locking assembly is switched by turning the knob. The structure is simple and the operation is convenient. The pushing device exerts an elastic pressing force in a direction away from the first body on the knob. As such, the friction between the knob and the second body during the rotation of the knob may be reduced, thereby improving the hand feeling. Furthermore, due to the special design of the pushing device, the user needs to overcome the pressing force of the pushing device to turn the knob to the unlocked state during the switching process from the locked state to the unlocked state, thereby improving the locking safety. As such, the locking safety is ensured while the feel of the turning operation is improved, and the second body is not easy to escape from the first body. In particular, for the battery and the UAV body, during the flight of the UAV, the battery can be stably connected to the UAV body to ensure stable power supply and reduce the accident rate of the UAV.

In one embodiment, in the process of switching from the locked state to the unlocked state, the knob 10 can push the pushing device 20 to move toward the first body 100, and the pushing force exerted by the pushing device 20 on the knob 10 gradually increases. In this way, if the user needs to unlock the locking assembly and switch from the locked state to the unlocked state, a relatively large torque needs to be applied, thereby effectively ensuring the locking stability of the second body 200 (such as a battery).

In the process of switching from the unlocked state to the locked state, the pushing device 20 moves away from the first body 100, and the pushing force applied by the pushing device 20 to the knob 10 gradually decreases. In this way, compared to switching to the unlocked state, it is easier for the user to switch the locking assembly to the locked state, which effectively reduces the difficulty of locking and can result in rapid locking.

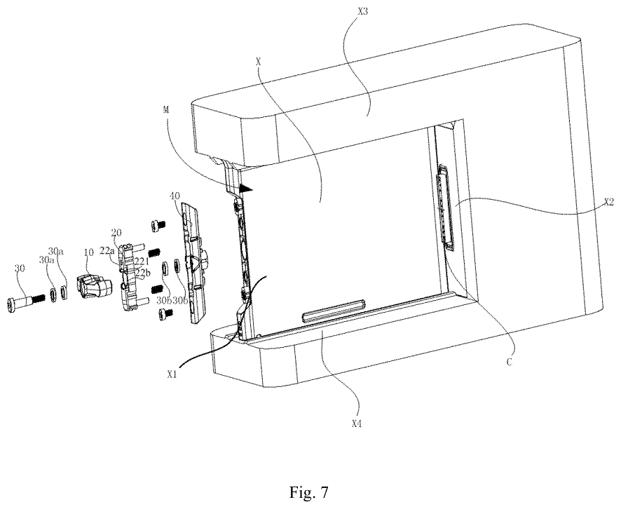

FIG. 7 is an exploded schematic diagram of a body, a battery, and a locking assembly of a movable platform provided by an embodiment of the present disclosure. As shown in FIGS. 1, 2 and 7, the pushing device 20 may include a floating block 21 and an elastic member 22. The floating block 21 may be used to push the knob 10, and the elastic member 22 is provided between the floating block 21 and the first body 100. In one embodiment, the floating block 21 may be in an elongated shape, and a cavity 211 for accommodating the elastic member 22 may be provided on the side of the floating block 21 away from the knob 10. The cavity 211 may be formed by a through hole or a groove. The entire floating block 21 may have a symmetrical structure with the rotation axis of the knob 10 as the center. There may be two cavities 211 and two elastic members 22. The two cavities 211 and the two elastic members 22 may be symmetrically arranged on both sides of the floating block 21 to balance the forces on both sides of the floating block 21.

In one embodiment, one end of the elastic member 22 may be fixedly connected to the floating block 21, and the other end of the elastic member 22 may be fixedly connected to the first body 100. In another embodiment, one end of the elastic member 22 is fixed and the other end abuts. In another embodiment, both ends of the elastic member 22 are not fixed, but are only compressed in the cavity 211.

In some embodiments, the elastic member 22 may be a compression spring, and in other embodiments, the elastic member 22 may be a rubber member.

In the process of switching from the locked state to the unlocked state, the elastic member 22 is gradually compressed. In the process of switching from the unlocked state to the locked state, the elastic member 22 gradually recovers from compressed deformation. It should be noted that the gradual recovery of deformation of the elastic member 22 means that the elastic member 22 gradually expands from the original amount of compression to reduce the amount of compression. But when the knob 10 is turned to a fully locked state (as shown in FIG. 6), the elastic member 22 may be in its original length or retain a certain amount of compression.

In some embodiments, the knob 10 and the pushing device 20 may be coaxially connected by a connecting shaft 30. One end of the connecting shaft 30 passes through the knob 10 and the pushing device 20 to be fixedly connected to the first body 100. The other end of the connecting shaft 30 has an axial limiting member 31 for axially limiting the knob 10 and the pushing device 20.

In one embodiment, the connecting shaft 30 may be a screw, and a nut of the screw forms the axial limiting member 31. Another nut may be embedded on the first body 100, and the end of the screw may be threadedly connected with the nut so that the connecting shaft 30 may be fixed. As such, the structure is simple, and the assembling is convenient. Of course, in other embodiments, the connecting shaft 30 may also have other structures, and this embodiment does not list examples one by one.

As shown in FIGS. 1 and 2, a first lubricating device 30a may be sleeved on the connecting shaft 30. In the axial direction of the connecting shaft 30, the first lubricating device 30a may be located between the axial limiting member 31 and the knob 10 and is used to reduce the friction coefficient between the knob 10 and the axial limiting member 31 when the knob 10 rotates. The first lubricating device 30a may include at least one of the following: a Teflon sheet, a copper sleeve, or a thrust bearing (not shown in the figure).

Similarly, a second lubricating device 30b may be sleeved on the connecting shaft 30. In the axial direction of the connecting shaft 30, the second lubricating device 30b is located between the knob 10 and the first body 100 for reducing the friction coefficient between the knob 10 and the first body 100 when the knob 10 is rotated. The second lubricating device 30b may include at least one of the following: a Teflon sheet, a copper sleeve, or a thrust bearing (not shown in the figure).

The first lubricating device 30a and the second lubricating device 30b can restrict their radial positions through the connecting shaft 30. The movement of the first lubricating device 30a is restricted by the gap between the axial limiting member 31 of the connecting shaft 30 and the knob 10. The movement of the second lubricating device 30b is restricted by the gap between the knob 10 and the first body 100.

Through the arrangement of the first lubricating device 30a and the second lubricating device 30b, the frictional force with the connecting shaft 30 and the pushing device 20 when the knob 10 is rotated can be effectively reduced. As such, the lubrication effect is improved, the assembly is reliable, and the operating feel of the knob 10 can be further improved, thereby improving user experience.

In some embodiments, a modular locking assembly is provided. For details, please refer to FIGS. 1, 2, 5 and 6. The modular locking assembly is used for locking the second body 200 onto the first body 100. The first body 100 has an accommodating cavity X for accommodating the second body 200. The locking assembly provided in this embodiment can be applied to movable platforms such as unmanned aerial vehicles, electric vehicles, sweeping robots, etc. The first body 100 may be the body of the above-mentioned machine, and the second body 200 may be a battery for powering the machine.

The accommodating cavity X may have an opening. The second body 200 may be detached from the accommodating cavity X from the opening, and can also be inserted into the accommodating cavity X from the opening. When the second body 200 is a battery, the accommodating cavity X may be also provided with a power supply terminal for docking with the battery. The battery has a power supply port, and the power supply port may be docked with the power supply terminal. Through the locking assembly, the docking state of the battery and the power supply terminal is maintained to ensure stability of the power supply.

Of course, it can be understood that the first body 100 and the second body 200 may also be two other components that need to be relatively locked, which are not particularly limited in these embodiments.

One embodiment of the present disclosure provides a lock assembly 300 with a simple structure and convenient operation, which can lock the second body 200 on the first body 100. The lock assembly 300 may include a knob 10 and a detachable member 40. The detachable member 40 and the first body 100 may be detachably fixed together. Optionally, the detachable member 40 and the first body 100 are detachably connected by connecting members such as screws, buckles, etc.

The knob 10 may be provided on the first body 100 through a detachable member 40. As such, the knob 10 can rotate around an axis relative to the first body 100. A connecting shaft may be connected to the first body 100, and the knob 10 may be sleeved on the outer side of the connecting shaft and can rotate around the axis of the connecting shaft. In one embodiment, the knob 10 may have a cylindrical body, and the cylindrical body is slidingly fitted with a corresponding structure on the first body 100. As such, the cylindrical body can be rotated, and the knob 10 can rotate around the virtual central axis of the cylindrical body when it is rotated.

The knob 10 may rotate to switch the locking assembly 300 between the locked state and the unlocked state. In the locked state, the knob 10 pushes and fixes the second body 200 in the accommodating cavity X. In the unlocked state, the knob 10 avoids the second body 200. In the unlocked state, the second body 200 can be freely inserted into the accommodating cavity X or pulled out from the accommodating cavity X.

The locking assembly provided by some embodiments of the present disclosure is used to lock the second body on the first body, and the locked state and the unlocked state of the locking assembly are switched by turning the knob. As such, the structure is simple and the operation is convenient. The pushing device exerts an elastic pushing force in a direction away from the first body on the knob, thereby reducing the friction between the knob and the second body during the rotation and accordingly improving the hand feeling. Furthermore, due to the design of the pushing device, the user needs to overcome the pressing force of the pushing device to turn the knob to the unlocked state during the switching process from the locked state to the unlocked state, thereby improving the locking safety. Therefore, the locking safety is ensured while the feel of the turning operation is improved, and the second body is not easy to fall out of the first body. In particular, for the battery and the UAV body, during the flight of the UAV, the battery can be stably connected to the UAV body to ensure stable power supply and reduce the accident rate of the UAV. In addition, since the modular design of the locking assembly is realized through the detachable member, the user can disassemble the detachable member from the first body to realize the disassembly of the whole locking assembly from the first body.

Generally, in order to improve the reliability of machine operation, the machine can be equipped with two or more batteries, so that at least one battery can be used as a backup battery to prevent the battery from being exhausted or malfunctioning. When the battery supplies power, the battery needs to be locked by a locking assembly to ensure the stability of the battery's electrical connection. In one embodiment, there are at least two second bodies 200. As shown in FIG. 5 and FIG. 6, taking two second bodies 200 as an example for description, the first body 100 may have two accommodating cavities X arranged side by side. Each accommodating cavity X is provided with a corresponding second body 200. The two accommodating cavities X can be separated by a middle side wall X1. The locking assembly 300 can be arranged on the middle side wall X1, and preferably, is located in the middle position of the middle side wall X1 so as to ensure maximum balance of forces on the two second bodies 200.

In one embodiment, as shown in FIG. 6, the knob 10 may include support arms 11, which are used to press against the second bodies 200. The number of support arms 11 may be equal to the number of the second bodies 200. Each support arm 11 correspondingly presses against a second body 200.

The at least two second bodies 200 may be evenly arranged. The knob 10 may be located in the middle position enclosed by the at least two second bodies 200. The included angle between every two adjacent second bodies 200 may be equal to the included angle between every two adjacent arms 11 of the knob. Specifically, for example, there may be two second bodies 200, and the knob 10 may have two support arms 11. The two second bodies 200 are arranged side by side, and the included angle between the two arms 11 of the knob 10 is approximately 180°.

Optionally, when the knob 10 is switched between the locked state and the unlocked state, the angle rotated by the knob 10 may be approximately 90°.

In one embodiment, taking FIGS. 5 and 6 as an example, in positions other than the unlocked state, the locking assembly 300 is in the intermediate locked state before the knob 10 reaches the horizontal position. As such, the second body 20 cannot fall out of the accommodating cavity X in the intermediate locked state.

The pushing device 20 is movably provided between the knob 10 and the first body 100 through the detachable member 40. The pushing device 20 is used to apply an elastic pressing force in a direction away from the first body 100 to the knob 10 during the rotation of the knob 10.

As shown in FIG. 8, the pushing device 20 may have a guiding surface 221, and the knob 10 may have a mating surface (not shown in the figure). During the rotation of the knob 10, the guiding surface 221 cooperates with the mating surface to push against the pushing device 20 while the knob 10 rotates. The guiding surface 221 may be an arc surface or an inclined surface.

In one embodiment, as shown in FIGS. 5, 6 and 8, the pushing device 20 has a first contact surface 22a and a second contact surface 22b. The guiding surface 221 is connected between the first contact surface 22a and the second contact surface 22b. In the unlocked state, the lower surface of the knob 10 is in contact with the first contact surface 22a. In the locked state, the lower surface of the knob 10 is in contact with the second contact surface 22b. The first contact surface 22a is higher than the second contact surface 22b.

In one embodiment, the pushing device 20 may have inserting posts 23 for inserting into the first body 100. During the movement of the pushing device 20, the position of the inserting post 23 in the first body 100 changes, so that an in-position detection device for detecting the position of the inserting post 23 may be provided in the body 100 to determine the state of the locking assembly. A waterproof sealing ring 24 may be sleeved on the inserting post 23. The waterproof sealing ring 24 may be located between the pushing device 20 and the detachable member 40. The inserting post 23 of the pushing device 20 slides in the waterproofing ring 24, so that the waterproof performance of the UAV is not affected.

In one embodiment, in the process of switching from the locked state to the unlocked state, the knob 10 can push the pushing device 20 to move toward the first body 100, and the pressing force exerted by the pushing device 20 on the knob 10 gradually increases. In the process of switching from the unlocked state to the locked state, the pushing device 20 moves away from the first body 100, and the pressing force applied by the pushing device 20 on the knob 10 gradually decreases.

As shown in FIGS. 1, 2 and 7, the pushing device 20 may include a floating block 21 and an elastic member 22. The floating block 21 may be used to push the knob 10. The elastic member 22 is disposed between the floating block 21 and the first body 100.

In the process of switching from the locked state to the unlocked state, the elastic member 22 is gradually compressed. In the process of switching from the unlocked state to the locked state, the elastic member 22 gradually recovers from deformation.

In some embodiments, the knob 10 and the pushing device 20 may be coaxially connected by a connecting shaft 30. One end of the connecting shaft 30 passes through the knob 10 and the pushing device 20 to be fixedly connected to the first body 100. The other end of the connecting shaft 30 has an axial limiting member 31 for axially limiting the knob 10 and the pushing device 20.

In one embodiment, the connecting shaft 30 may be a screw, and the nut of the screw forms the axial limiting member 31.

As shown in FIGS. 1 and 2, a first lubricating device 30a may be sleeved on the connecting shaft 30. In the axial direction of the connecting shaft 30, the first lubricating device 30a may be located between the axial limiting member 31 and the knob 10. The first lubricating device 30a may be used to reduce the friction coefficient between the knob 10 and the axial limiting member 31 when the knob 10 is rotated. The first lubricating device 30a may include at least one of the following: a Teflon sheet, a copper sleeve, or a thrust bearing (not shown in the figure).

Similarly, a second lubricating device 30b may be sleeved on the connecting shaft 30. In the axial direction of the connecting shaft 30, the second lubricating device 30b may be located between the knob 10 and the first body 100 for reducing the friction coefficient between the knob 10 and the first body 100 when the knob 10 is rotated. The second lubricating device 30b may include at least one of the following: a Teflon sheet, a copper sleeve, or a thrust bearing (not shown in the figure).

On the premise of no conflict, other specific structures and specific functions of the locking assembly provided in these embodiments except for the detachable member are the same as those of the foregoing embodiments. For details, reference may be made to the description of the foregoing embodiments, which will not be repeated here.

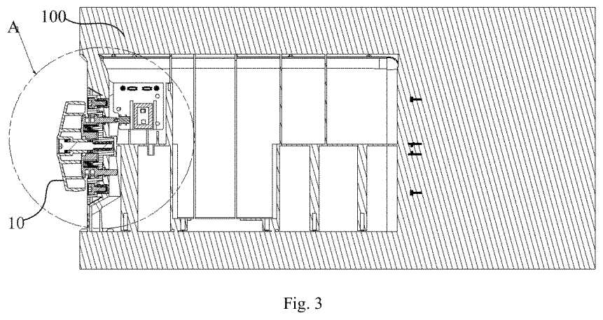

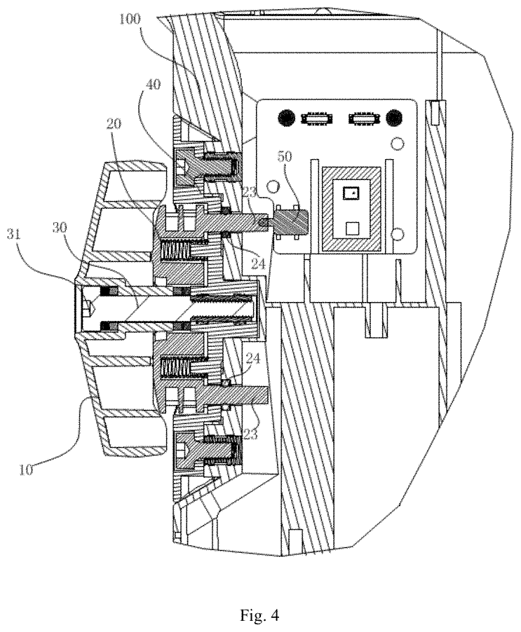

In some embodiments, a locking assembly that can know the state of the lock assembly is provided. FIG. 3 is a schematic diagram of the mating state of the locking assembly with the first body in the unlocked state provided by one embodiment of the present disclosure. FIG. 4 is an enlarged view of A in FIG. 3. Optionally, please refer to FIGS. 1-6, the locking assembly 300 is used to lock the second body 200 on the first body 100. The first body 100 has an accommodating cavity X for accommodating the second body 200. The first body may have an in-position detection device 50, which is used to detect the state of the locking assembly 300. The locking assembly provided in this embodiment can be applied to movable platforms such as unmanned aerial vehicles, electric vehicles, sweeping robots, etc. The first body 100 can be the body of the above-mentioned machine, and the second body 200 can be a battery for powering the machine.

The accommodating cavity X may have an opening. The second body 200 may be detached from the accommodating cavity X from the opening, and also be inserted into the accommodating cavity X from the opening. When the second body 200 is a battery, the accommodating cavity X may also be provided with a power supply terminal for docking with the battery. The battery may have a power supply port, and the power supply port may be docked with the power supply terminal. Through the locking assembly, the docking state of the battery and the power supply terminal may be maintained to ensure stability of power supply.

Of course, it can be understood that the first body 100 and the second body 200 may also be two other components that need to be relatively locked, which are not particularly limited in the embodiments.

One embodiment of the present disclosure provides a locking assembly 300 with a simple structure and convenient operation, which can lock the second body 200 on the first body 100. The locking assembly 300 may include a knob 10.

In one embodiment, the locking assembly 300 may further include a detachable member 40, and the detachable member 40 and the first body 100 are detachably fixed together. Optionally, the detachable member 40 and the first body 100 are detachably connected by a connecting member such as a screw and a buckle.

The knob 10 may be provided on the first body 100, and specifically can be provided on the first body 100 by a detachable member. The knob 10 can rotate around an axis relative to the first body 100. A connecting shaft may be connected to the first body 100. The knob 10 may be sleeved on the outer side of the connecting shaft and can rotate around the axis of the connecting shaft. In one embodiment, the knob 10 may have a cylindrical body. The cylindrical body is slidingly fitted with a corresponding structure on the first body 100, so that the cylindrical body can be rotated. The knob 10 can rotate around the virtual central axis of the cylindrical body when it is rotated.

The knob 10 may rotate to switch the locking assembly 300 between the locked state and the unlocked state. In the locked state, the knob 10 pushes and fixes the second body 200 in the accommodating cavity X. In the unlocked state, the knob 10 avoids the second body 200. In the unlocked state, the second body 200 can be freely inserted into the accommodating cavity X or pulled out from the accommodating cavity X.

In one embodiment, when in the locked state, the locking assembly is in the first position. When in the unlocked state, the locking assembly 300 is in the second position. The locking assembly 300 may cooperate with the in-position detection device 50 so that the in-position detection device 50 can determine the state of the lock assembly 300 based on the detected position of the lock assembly 300.

The locking assembly provided by one embodiment of the present disclosure is used to lock the second body on the first body. The locked state and the unlocked state of the locking assembly are switched by turning the knob. As such, the structure is simple and the operation is convenient. The pushing device exerts an elastic pressing force in a direction away from the first body on the knob, thereby reducing the friction between the knob and the second body during the rotation of the knob and accordingly improving the hand feeling. Due to the design of the pushing device, the user needs to overcome the pushing force of the pushing device to turn the knob to the unlocked state during the switching process from the locked state to the unlocked state, thereby improving the locking safety. Therefore, the locking safety is ensured while the feel of the turning operation is improved. Furthermore, it is not easy for the second body to escape from the first body. Especially for the battery and the UAV body, the battery can be stably connected to the UAV body during the flight of the UAV to ensure stable power supply, thereby reducing the accident rate of unmanned aerial vehicles. In addition, the in-position detection device detects the position of the locking assembly, which realizes the self-detection of the unlocking knob of the battery before the unmanned aerial vehicle takes off. This may prevent the take-off when the battery is not locked, thereby improving the safety of the UAV.

Generally, in order to improve the reliability of machine operation, the machine may be equipped with two or more batteries, so that at least one battery can be used as a backup battery. When one battery is exhausted or malfunctions, the machine can be powered by the backup battery. When the battery is supplying power, the battery needs to be locked by a locking assembly to ensure the stability of the electrical connection of the battery. In one embodiment, there are at least two second bodies 200. As shown in FIG. 5 and FIG. 6, taking two second bodies 200 as an example for description, the first body 100 may have two accommodating cavities X arranged side by side. Each accommodating cavity X is provided with a corresponding second body 200. The two accommodating cavities X can be separated by a middle side wall X1. The locking assembly 300 can be arranged on the middle side wall X1, and preferably, is located in the middle position of the middle side wall X1 so as to ensure maximum balance of the forces on the two second bodies 200.

In one embodiment, as shown in FIG. 6, the knob 10 may include support arms 11, which are used to press against the second bodies 200. The number of support arms 11 may be equal to the number of the second bodies 200. Each support arm 11 correspondingly presses against a second body 200.

The at least two second bodies 200 may be evenly arranged, and the knob 10 may be located in the middle position enclosed by the at least two second bodies 200. The included angle between every two adjacent second bodies 200 may be equal to the included angle between every two adjacent arms 11 of the knob. Specifically, for example, there may be two second bodies 200, and the knob 10 may have two support arms 11. The two second bodies 200 may be arranged side by side, and the included angle between the two support arms 11 of the knob 10 may be approximately 180°.

Optionally, when the knob 10 is switched between the locked state and the unlocked state, the angle rotated by the knob 10 is approximately 90°.

Of course, it can be understood that taking FIGS. 5 and 6 as an example, in positions other than the unlocked state, the locking assembly 300 is in the intermediate locked state before the knob 10 reaches the horizontal position. Similarly, the second body 20 cannot fall out of the accommodating cavity X in the intermediate locked state.

The pressing device 20 may be movably arranged between the knob 10 and the first body 100. Optionally, the pushing device 20 may be provided between the knob 10 and the first body 100 through a detachable member. The pressing device 20 may be used to apply an elastic pressing force in a direction away from the first body 100 to the knob 10 during the rotation of the knob 10.

As shown in FIG. 8, the pushing device 20 may have a guiding surface 221, and the knob 10 may have a mating surface (not shown in the figure). During the rotation of the knob 10, the guiding surface 221 cooperates with the mating surface to push against the pushing device 20 while the knob 10 rotates. Optionally, the guiding surface 221 may be an arc surface or an inclined surface.

In one embodiment, as shown in FIGS. 5, 6 and 8, the pushing device 20 has a first contact surface 22a and a second contact surface 22b. The guiding surface 221 is connected between the first contact surface 22a and the second contact surface 22b. In the unlocked state, the lower surface of the knob 10 contacts the first contact surface 22a. In the locked state, the lower surface of the knob 10 contacts the second contact surface 22b. The first contact surface 22a is higher than the second contact surface 22b.

In addition, the pushing device 20 may have inserting posts 23 for inserting into the first body 100. During the movement of the pushing device 20, the position of the inserting post 23 in the first body 100 changes. In this way, an in-position detection device 50 for detecting the position of the inserting post 23 can be provided in the first body 100 to determine the state of the locking assembly. A waterproof sealing ring 24 may be sleeved on the inserting post 23. The waterproof sealing ring 24 may be located between the pushing device 20 and the detachable member 40. The inserting post 23 of the pushing device 20 may slide in the waterproofing ring 24, which does not affect the waterproof performance of the UAV itself.

In one embodiment, as shown in FIG. 3, in the unlocked state, the end of the inserting post 23 is in contact with the in-position detection device 50. As shown in FIG. 4, in the locked state, the end of the inserting post 23 is not in contact with the in-position detection device 50. In another embodiment, in the unlocked state, the end of the inserting post 23 does not contact the in-position detection device 50, and in the locked state, the end of the inserting post 23 contacts the in-position detection device 50.

In some embodiments, the in-position detection device 50 can also determine the state of the locking assembly by measuring the height of the inserting post 23, for example, by a distance sensor.

Further, the first body 100 of this embodiment may also be provided with a prompting device (not shown in the figure), which may be electrically connected to the in-position detection device 50. The prompting device may be used for sending out prompting information when the in-position detection device 50 detects that the inserting post 23 is at a preset position. The prompt information sent by the prompting device may be at least one of information such as voice, light, or text.

In one embodiment, in the process of switching from the locked state to the unlocked state, the knob 10 can push the pushing device to move toward the first body 100, and the pressing force exerted by the pushing device 20 on the knob 10 gradually increases.

In the process of switching from the unlocked state to the locked state, the pushing device 20 moves away from the first body 100, and the pushing force applied by the pushing device 20 on the knob 10 gradually decreases.

As shown in FIGS. 1, 2 and 7, the pushing device 20 may include a floating block 21 and an elastic member 22. The floating block 21 may be used to push the knob 10. The elastic member 22 may be disposed between the floating block 21 and the first body 100.

In the process of switching from the locked state to the unlocked state, the elastic member 22 may be gradually compressed. In the process of switching from the unlocked state to the locked state, the elastic member 22 may gradually recover from deformation.

In some embodiments, the knob 10 and the pushing device 20 may be coaxially connected by a connecting shaft 30. One end of the connecting shaft 30 passes through the knob 10 and the pushing device 20 to be fixedly connected to the first body 100. The other end of the connecting shaft 30 has an axial limiting member 31 for axially limiting the positions of the knob 10 and the pushing device 20.

In one embodiment, the connecting shaft 30 may be a screw, and the nut of the screw forms the axial limiting member 31.

As shown in FIGS. 1 and 2, a first lubricating device 30a may be sleeved on the connecting shaft 30. In the axial direction of the connecting shaft 30, the first lubricating device 30a may be located between the axial limiting member 31 and the knob 10. The first lubricating device 30a may be used to reduce the friction coefficient between the knob 10 and the axial limiting member 31 when the knob 10 rotates. The first lubricating device 30a may include at least one of the following: a Teflon sheet, a copper sleeve, or a thrust bearing (not shown in the figure).

Similarly, a second lubricating device 30b may be sleeved on the connecting shaft 30. In the axial direction of the connecting shaft 30, the second lubricating device 30b may be located between the knob 10 and the first body 100 for reducing the friction coefficient between the knob 10 and the first body 100 when the knob 10 is rotated. The second lubricating device 30b may include at least one of the following: a Teflon sheet, a copper sleeve, or a thrust bearing (not shown in the figure).

On the premise of no conflict, other specific structures and specific functions of the locking assembly provided in these embodiments except the in-position detection device are the same as those in the foregoing embodiment. For details, reference may be made to the description of the foregoing embodiment, which will not be repeated here.

In some embodiments, a movable platform is provided. Please refer to FIGS. 1, 2, 5, and 6. The movable platform provided in this embodiment includes a body 100, a battery 200, and a lock assembly for locking the battery 200 on the body 100. The body 100 has an accommodating cavity X for accommodating the battery 200. Among them, the locking assembly can be applied to movable platforms such as unmanned aerial vehicles, electric vehicles, sweeping robots, etc. In the case of unmanned aerial vehicles, the body 100 is the body of unmanned aerial vehicles.

The accommodating cavity X may have an opening. The battery 200 can be detached from the accommodating cavity X through the opening, and can also be inserted into the accommodating cavity X through the opening. Furthermore, the accommodating cavity X may be also provided with a power supply terminal for docking with the battery. The battery may have a power supply port, and the power supply port may be docked with the power supply terminal. Through the locking assembly, the docking state of the battery and the power supply terminal may be maintained to ensure stable power supply.

The accommodating cavity X of this embodiment may include a vertical wall X2 provided with a power supply terminal C, a side wall connected to the vertical wall X2, and an opening M for the battery 200 to escape from the accommodating cavity X in the escaping direction. The opening M is disposed opposite to the vertical wall X2.

In one embodiment, there are at least two side walls (for example, the middle side wall X1, the upper side wall X3, and the lower side wall X4 as shown in FIG. 7). A sliding rail L1 is provided on at least one of the two opposite side walls. The battery 200 has a slideway L2 that cooperates with the sliding rail L1. The sliding rail L1 cooperates with the slideway L2 to guide the battery 200 to extend into the accommodating cavity X.

Optionally, the sliding rail L1 extends toward the vertical wall X2 to prevent the battery 200 from moving along the direction perpendicular to the installation direction of the battery 200. This may prevent the battery 200 from falling off along the left and right sides, thereby further improving stability of the battery 200 installation. Optionally, the number of side walls is four, and the four side walls enclose the accommodating cavity X. The four side walls can also effectively prevent the battery 200 from falling off in the left or right direction. In another embodiment, the blocking portion may be formed by other components on the body 100 to prevent the battery 200 from falling out of the accommodating cavity X.

One embodiment of the present disclosure provides a lock assembly 300 with a simple structure and convenient operation, which can lock the battery 200 on the body 100. The lock assembly 300 includes a knob 10 and a pushing device 20. The knob 10 is provided on the body 100, and the knob 10 can rotate around an axis relative to the body 100. The pressing device 20 may be used to apply an elastic pressing force in a direction away from the body 100 to the knob 10 during the rotation of the knob 10. Further, FIG. 8 is a schematic structural diagram of a pushing device of a locking assembly provided by an embodiment of the present disclosure. As shown in FIG. 8, the pushing device 20 may have a guiding surface 221, and the knob 10 may have a mating surface (not shown in the figure). During the rotation of the knob 10, the guiding surface 221 cooperates with the mating surface to push against the pushing device 20 while the knob 10 rotates.

Optionally, the guiding surface 221 may be an arc surface or an inclined surface. In one embodiment, as shown in FIGS. 5, 6 and 8, the pushing device 20 has a first contact surface 22a and a second contact surface 22b. The guiding surface 221 is connected between the first contact surface 22a and the second contact surface 22b. In the unlocked state, the lower surface of the knob 10 contacts the first contact surface 22a. In the locked state, the lower surface of the knob 10 contacts the second contact surface 22b. The first contact surface 22a is higher than the second contact surface 22b. In addition, the pushing device 20 may have inserting posts 23 for inserting into the body 100. During the movement of the pushing device 20, the position of the inserting post 23 in the body 100 changes. In this way, an in-position detection device for detecting the position of the inserting post 23 can be provided in the body 100 to determine the state of the locking assembly.

The knob 10 may rotate to switch the locking assembly 300 between the locked state and the unlocked state. In the locked state, the knob 10 pushes and fixes the battery 200 in the accommodating cavity X. In the unlocked state, the knob 10 avoids the battery 200. In the unlocked state, the battery 200 can be freely inserted into the accommodating cavity X or pulled out of the accommodating cavity X.

In one embodiment, as shown in FIG. 6, the knob 10 may include support arms 11, which are used to press against the batteries 200. The number of the support arms 11 may be equal to the number of the batteries 200. Each support arm 11 correspondingly presses against a battery 200.

The at least two batteries 200 may be evenly arranged, and the knob 10 may be located in the middle position enclosed by the at least two batteries 200. The included angle between every two adjacent batteries 200 may be equal to the included angle between every two adjacent support arms 11 of the knob. Optionally, when the knob 10 is switched between the locked state and the unlocked state, the angle rotated by the knob 10 is approximately 90°. In addition, the length of the arm 11 of the knob 10 can be as long as possible, so that a larger torque can be output to overcome the elastic pressing force of the pushing device 20. As such, the unlocking and locking operations may be labor-saving.

The locking assembly provided by one embodiment of the present disclosure is used to lock the battery on the body. The locked state and the unlocked state of the locking assembly are switched by turning the knob. This embodiment has advantages such as simple structure and convenient operation. The pushing device applies an elastic pressing force in a direction away from the body to the knob, thereby reducing the friction between the knob and the battery and accordingly improving the hand feeling during the rotation process. Furthermore, due to the design of the pushing device, the user needs to overcome the pressing force of the pushing device to turn the knob to the unlocked state during the switching process from the locked state to the unlocked state, thereby improving the locking safety. Therefore, while the feel of the rotating operation is improved, the locking safety is also ensured, and the battery is not easily escaped from the body. In particular, for the battery and the UAV body, during the flight of the UAV, the battery can be stably connected to the UAV body to ensure stable power supply and reduce the accident rate of the UAV.

In one embodiment, in the process of switching from the locked state to the unlocked state, the knob 10 may push the pushing device 20 to move closer to the body 100, and the pressing force exerted by the pushing device 20 on the knob 10 gradually increases.

In the process of switching from the unlocked state to the locked state, the pushing device 20 moves away from the body 100, and the pressing force exerted by the pushing device 20 on the knob 10 gradually decreases.

FIG. 7 is an exploded schematic diagram of a body, a battery, and a locking assembly of a movable platform provided by an embodiment of the present disclosure. As shown in FIG. 1, FIG. 2 and FIG. 7, the pushing device 20 may include a floating block 21 and an elastic member 22, The floating block 21 may be used to push the knob 10, and the elastic member 22 may be provided between the floating block 21 and the body 100.

In the process of switching from the locked state to the unlocked state, the elastic member 22 may be gradually compressed. In the process of switching from the unlocked state to the locked state, the elastic member 22 may gradually recover from deformation.

In some embodiments, the knob 10 and the pushing device 20 may be coaxially connected by a connecting shaft 30. One end of the connecting shaft 30 passes through the knob 10 and the abutting device 20 to be fixedly connected to the body 100. The other end of the connecting shaft 30 has an axial limiting member 31 for axially limiting the positions of the knob 10 and the pushing device 20.

Optionally, the connecting shaft 30 may be a screw, and the nut of the screw may form the axial limiting member 31. Another nut may be embedded on the first body 100. The end of the screw is threadedly connected with the another nut so that the connecting shaft 30 is fixed. As such, the structure is simple, and the assembly is convenient. Of course, in other embodiments, the connecting shaft 30 may also have other structures, and these embodiments do not give examples one by one.

As shown in FIGS. 1 and 2, a first lubricating device 30a may be sleeved on the connecting shaft 30. In the axial direction of the connecting shaft 30, the first lubricating device 30a may be located between the axial limiting member 31 and the knob 10. The first lubricating device 30a may be used to reduce the friction coefficient between the knob 10 and the axial limiting member 31 when the knob 10 is rotated. The first lubricating device 30a may include at least one of the following: a Teflon sheet, a copper sleeve, or a thrust bearing (not shown in the figure).

Similarly, a second lubricating device 30b may be sleeved on the connecting shaft 30. In the axial direction of the connecting shaft 30, the second lubricating device 30b may be located between the knob 10 and the first body 100 for reducing the friction coefficient between the knob 10 and the first body 100 when the knob 10 is rotated. The second lubricating device 30b may include at least one of the following: a Teflon sheet, a copper sleeve, or a thrust bearing (not shown in the figure).

The first lubricating device 30a and the second lubricating device 30b may restrict their radial positions through the connecting shaft 30. The movement of the first lubricating device 30a may be restricted by the gap between the axial limiting member 31 of the connecting shaft 30 and the knob 10. The movement of the second lubricating device 30b may be restricted by the gap between the knob 10 and the first body 100.

Through the arrangement of the first lubricating device 30a and the second lubricating device 30b, the frictional force with the connecting shaft 30 and the pushing device 20 when the knob 10 is rotated can be effectively reduced. As such, the lubrication effect is improved, the assembly is reliable, and the operating feel of the knob 10 can be further improved, thereby improving user experience.

On the premise of no conflict, other specific structures and specific functions of the locking assembly in the movable platform provided in these embodiments are the same as those in the foregoing embodiment. For details, reference may be made to the description of the foregoing embodiment, which will not be repeated here.

In some embodiments, a movable platform is provided, which has a modular locking assembly. For details, please refer to FIGS. 1, 2, 5, and 6. The movable platform of this embodiment includes a body 100, a battery 200, and a locking assembly 300. The locking assembly 300 is used to lock the battery 200 on the body 100. The body 100 has an accommodating cavity X for accommodating the battery 200. The locking assembly provided in this embodiment can be applied to movable platforms such as unmanned aerial vehicles, electric vehicles, and sweeping robots. The body 100 can be the body of the above-mentioned machine, and the battery 200 can be a battery for powering the machine.

The accommodating cavity X may have an opening. The battery 200 may be detached from the accommodating cavity X through the opening, and may also be inserted into the accommodating cavity X through the opening. The accommodating cavity X may also be provided with a power supply terminal for docking with the battery. The battery may have a power supply port, and the power supply port may be docked with the power supply terminal. Through the locking assembly, the docking state of the battery and the power supply terminal may be maintained to ensure stable power supply.

The accommodating cavity X of this embodiment may include a vertical wall X2 provided with a power supply terminal C, a side wall connected to the vertical wall X2, and an opening M for the battery 200 to escape from the accommodating cavity X in an escaping direction. The opening M may be disposed opposite to the vertical wall X2.

Optionally, there are at least two side walls (for example, the middle side wall X1, the upper side wall X3, and the lower side wall X4 as shown in FIG. 7). A sliding rail L1 may be provided on at least one of the two opposite side walls. The battery 200 has a slideway L2 that is matched with the sliding rail L1, and the sliding rail L1 and the slideway L2 cooperate to guide the battery 200 to extend into the accommodating cavity X.

In addition, the sliding rail L1 extend toward the vertical wall X2 to prevent the battery 200 from moving along the direction perpendicular to the installation direction of the battery 200. This prevents the battery 200 from falling off along the left and right sides, and further improves the stability of the battery 200 installation. Optionally, the number of side walls is four, and the four side walls enclose the accommodating cavity X. The four side walls can also effectively prevent the battery 200 from falling off in the left or right direction. In another embodiment, the blocking portion may be formed by other components on the body 100 to prevent the battery 200 from falling out of the accommodating cavity X.

Of course, it can be understood that the body 100 and the battery 200 may also be two other components that need to be relatively locked, which is not particularly limited in this embodiment.

One embodiment of the present disclosure provides a lock assembly 300 with a simple structure and convenient operation, which can lock the battery 200 on the body 100. The lock assembly 300 includes a knob 10 and a detachable member 40. Wherein, the detachable member 40 and the body 100 are detachably fixed together. Optionally, the detachable member 40 and the body 100 are detachably connected by connecting members such as screws and buckles.

Optionally, the knob 10 is provided on the body 100 through a detachable member 40. The knob 10 can rotate around an axis relative to the body 100. A connecting shaft may be connected to the body 100, and the knob 10 may be sleeved on the outer side of the connecting shaft and can rotate around the axis of the connecting shaft. In one embodiment, the knob 10 may have a cylindrical body. The cylindrical body is slidingly fitted with a corresponding structure on the body 100, so that the cylindrical body can be rotated. When it is rotated, the knob 10 can rotate around the virtual central axis of the cylindrical body.

The knob 10 may rotate to switch the locking assembly 300 between the locked state and the unlocked state. In the locked state, the knob 10 pushes and fixes the battery 200 in the accommodating cavity X. In the unlocked state, the knob 10 avoids the battery 200. In the unlocked state, the battery 200 can be freely inserted into the accommodating cavity X or pulled out of the accommodating cavity X.

The movable platform provided by one embodiment of the present disclosure is used for locking the battery on the body. The locked state and the unlocked state of the locking component are switched by turning the knob. As such, the structure is simple and the operation is convenient. The pushing device applies an elastic pressing force in a direction away from the body on the knob, thereby reducing the friction between the knob and the battery during the rotation and accordingly improving the hand feel. Furthermore, due to the design of the pushing device, the user needs to overcome the pressing force of the pushing device to turn the knob to the unlocked state during the switching process from the locked state to the unlocked state, thereby improving the locking safety. As such, while improving the feel of turning operation, it also guarantees the locking safety, and the battery is not easy to escape from the body. Optionally, for the battery and the UAV body, during the flight of the UAV, the battery can be stably connected to the UAV body to ensure stable power supply and reduce the accident rate of the UAV. In addition, since the modular design of the locking assembly is realized by the detachable member, the user can disassemble the detachable member from the body to realize the disassembly of the whole locking assembly from the body.

Generally, in order to improve the reliability of machine operation, the machine can be equipped with two or more batteries, so that at least one battery can be used as a backup battery to prevent the battery from running out or malfunctioning. When the battery is supplying power, the battery needs to be locked by a locking assembly to ensure the stability of the electrical connection of the battery. In one embodiment, there are at least two batteries 200. As shown in FIGS. 5 and 6, taking two batteries 200 as an example for description, the body 100 may have two accommodating cavities X arranged side by side. Each accommodating cavity X is provided with a battery 200 correspondingly. The two accommodating cavities X can be separated by a middle side wall X1. The locking assembly 300 can be arranged on the middle side wall X1, and preferably, is located on the middle part of the middle side wall X1. This can ensure the maximum balance of forces on the two batteries 200.

Optionally, as shown in FIG. 6, the knob 10 may include support arms 11, which are used to press against the batteries 200. The number of the support arms 11 may be equal to the number of the batteries 200. Each support arm 11 correspondingly presses against a battery 200.

The at least two batteries 200 can be evenly arranged, and the knob 10 can be located in the middle position enclosed by the at least two batteries 200. The included angle between every two adjacent batteries 200 may be equal to the included angle between every two adjacent arms 11 of the knob. Specifically, for example, there may be two batteries 200, and the knob 10 has two arms 11. The two batteries 200 are arranged side by side, and the included angle between the two arms 11 of the knob 10 is approximately 180°.

Optionally, when the knob 10 is switched between the locked state and the unlocked state, the angle rotated by the knob 10 is substantially 90°.

Of course, it can be understood that taking FIGS. 5 and 6 as an example, in positions other than the unlocked state, before the knob 10 reaches the horizontal position, the locking assembly 300 is in the intermediate locked state. Similarly, in the intermediate locked state, the battery 20 cannot be removed from the accommodating cavity X.

Optionally, the pushing device 20 is movably provided between the knob 10 and the body 100 through a detachable member 40. The pushing device 20 is used to apply an elastic pressing force in a direction away from the body 100 to the knob 10 during the rotation of the knob 10.

Optionally, as shown in FIG. 8, the pushing device 20 may have a guiding surface 221, and the knob 10 may have a mating surface (not shown in the figure). During the rotation of the knob 10, the guiding surface 221 cooperates with the mating surface to push against the pushing device 20 while the knob 10 rotates. The guiding surface 221 may be an arc surface or an inclined surface.

In one embodiment, as shown in FIGS. 5, 6 and 8, the pushing device 20 has a first contact surface 22a and a second contact surface 22b. The guiding surface 221 is connected between the first contact surface 22a and the second contact surface 22b. In the unlocked state, the lower surface of the knob 10 contacts the first contact surface 22a. In the locked state, the lower surface of the knob 10 contacts the second contact surface 22b. The first contact surface 22a is higher than the second contact surface 22b.

In addition, the pushing device 20 may have inserting posts 23 for inserting into the body 100. During the movement of the pushing device 20, the position of the inserting post 23 in the body 100 changes. In this way, an in-position detection device for detecting the position of the inserting post 23 can be provided in the body 100 to determine the state of the locking assembly. A waterproof sealing ring 24 may be sleeved on the inserting post 23. The waterproof sealing ring 24 may be located between the pushing device 20 and the detachable member 40. The inserting post 23 of the pushing device 20 may slide in the waterproofing ring 24, and thus does not affect the waterproof performance of the UAV itself.

In one embodiment, in the process of switching from the locked state to the unlocked state, the knob 10 can push the pushing device 20 to move closer to the body 100, and the pressing force exerted by the pushing device 20 on the knob 10 gradually increases.

In the process of switching from the unlocked state to the locked state, the pushing device 20 moves away from the body 100, and the pressing force exerted by the pushing device 20 on the knob 10 gradually decreases.

As shown in FIGS. 1, 2 and 7, the pushing device 20 may include a floating block 21 and an elastic member 22. The floating block 21 may be used to push the knob 10. The elastic member 22 may be provided between the floating block 21 and the body 100.

In the process of switching from the locked state to the unlocked state, the elastic member 22 may be gradually compressed. In the process of switching from the unlocked state to the locked state, the elastic member 22 gradually recover from deformation.

In some embodiments, the knob 10 and the pushing device 20 may be coaxially connected by a connecting shaft 30. One end of the connecting shaft 30 passes through the knob 10 and the pushing device 20 to be fixedly connected to the body 100. The other end of the connecting shaft 30 has an axial limiting member 31 for axially limiting the positions of the knob 10 and the pushing device 20.

Optionally, the connecting shaft 30 may be a screw, and the nut of the screw may form the axial limiting member 31.

As shown in FIGS. 1 and 2, a first lubricating device 30a may be sleeved on the connecting shaft 30. In the axial direction of the connecting shaft 30, the first lubricating device 30a may be located between the axial limiting member 31 and the knob 10. The first lubricating device 30a may be used to reduce the friction coefficient between the knob 10 and the axial limiting member 31 when the knob 10 rotates. The first lubricating device 30a may include at least one of the following: a Teflon sheet, a copper sleeve, or a thrust bearing (not shown in the figure).

Similarly, a second lubricating device 30b may be sleeved on the connecting shaft 30. In the axial direction of the connecting shaft 30, the second lubricating device 30b may be located between the knob 10 and the body 100. The second lubricating device 30b may be used to reduce the friction coefficient between the knob 10 and the body 100 when the knob 10 is rotated. The second lubricating device 30b may include at least one of the following: a Teflon sheet, a copper sleeve, or a thrust bearing (not shown in the figure).

On the premise of no conflict, the specific structure and specific functions of the locking assembly in the movable platform provided in these embodiments except for the detachable member are the same as those in the above embodiment. For details, please refer to the description of the above embodiments, which will not be repeated here.

In some embodiments, a movable platform is provided, which has a locking assembly that can know the state of the locking assembly. FIG. 3 is a schematic diagram of the mating state of the locking assembly provided by the embodiment of the present disclosure with the body when it is in the unlocked state. FIG. 4 is an enlarged view of area A in FIG. 3. Specifically, please refer to FIGS. 1-6. The movable platform of this embodiment includes a body 100, a battery 200, and a locking assembly 300. The locking assembly 300 is used to lock the battery 200 on the body 100. The body 100 has an accommodating cavity X for accommodating the battery 200 and an in-position detection device 50, which is used to detect the state of the locking assembly 300. The locking assembly provided in this embodiment can be applied to movable platforms such as unmanned aerial vehicles, electric vehicles, sweeping robots, etc. The body 100 can be the body of the above-mentioned machine, and the battery 200 can be a battery for powering the machine.

The accommodating cavity X may have an opening, and the battery 200 can be detached from the accommodating cavity X through the opening, and can also be inserted into the accommodating cavity X through the opening. The accommodating cavity X may be also provided with a power supply terminal for docking with the battery. The battery may have a power supply port, and the power supply port is docked with the power supply terminal. Through the locking assembly, the docking state of the battery and the power supply terminal may be maintained to ensure stable power supply.

The accommodating cavity X of this embodiment may include a vertical wall X2 provided with a power supply terminal C, a side wall connected to the vertical wall X2, and an opening M for the battery 200 to escape from the accommodating cavity X in an escaping direction. The opening M may be arranged opposite to the vertical wall X2.

Optionally, there are at least two side walls (for example, the middle side wall X1, the upper side wall X3, and the lower side wall X4 as shown in FIG. 7). A sliding rail L1 is provided on at least one of the two opposite side walls. The battery 200 has a slideway L2 that is matched with the sliding rail L1. The sliding rail L1 and the slideway L2 cooperate to guide the battery 200 to extend into the accommodating cavity X.

Optionally, the sliding rail L1 extends toward the vertical wall X2 to prevent the battery 200 from moving along the direction perpendicular to the installation direction of the battery 200. This prevents the battery 200 from falling off along the left and right directions, and further improves the stability of the battery 200 installation. Optionally, the number of side walls is four, and the four side walls enclose the accommodating cavity X. The four side walls can also effectively prevent the battery 200 from falling off in the left or right direction. In another embodiment, the blocking portion may be formed by other components on the body 100 to prevent the battery 200 from falling out of the accommodating cavity X.

Of course, it can be understood that the body 100 and the battery 200 may also be two other components that need to be relatively locked, which are not particularly limited in this embodiment.

One embodiment of the present disclosure provides a lock assembly 300 with a simple structure and convenient operation, which can lock the battery 200 on the body 100. The lock assembly 300 may include a knob 10.

In one embodiment, the locking assembly 300 may further include a detachable member 40, and the detachable member 40 is detachably fixed with the body 100. Optionally, the detachable member 40 and the body 100 are detachably connected by connecting members such as screws and buckles.

Optionally, the knob 10 is provided on the body 100, and specifically can be provided on the body 100 through a detachable member. The knob 10 can rotate around an axis relative to the body 100. A connecting shaft may be connected to the body 100, and the knob 10 may be sleeved on the outer side of the connecting shaft and rotate around the axis of the connecting shaft. In one embodiment, the knob 10 may have a cylindrical body. The cylindrical body is slidingly fitted with a corresponding structure on the body 100, so that the cylindrical body can be rotated. The knob 10 can rotate around the virtual central axis of the cylindrical body when it is rotated.

Optionally, the knob 10 rotates to switch the locking assembly 300 between the locked state and the unlocked state. In the locked state, the knob 10 pushes and fixes the battery 200 in the accommodating cavity X. In the unlocked state, the knob 10 avoids the battery 200. In the unlocked state, the battery 200 can be freely inserted into the accommodating cavity X or pulled out of the accommodating cavity X. In one embodiment, when in the locked state, the locking assembly is in the first position. When in the unlocked state, the locking assembly 300 is in the second position. wherein, the locking assembly 300 may be used to cooperate with the in-position detection device 50 so that the in-position detection device 50 can determine the state of the locking assembly 300 based on the detected position of the locking assembly 300.

In the movable platform provided by the embodiment of the present disclosure, the locking assembly is used to lock the battery on the body, and the locking state or the unlocking state of the locking component are switched by turning the knob. As such, the structure is simple, and the operation is convenient. The pushing device applies an elastic pressing force in a direction away from the body to the knob, thereby reducing the friction between the knob and the battery during the rotation and accordingly improving the hand feel. Furthermore, due to the design of the pushing device, the user needs to overcome the pressing force of the pushing device to turn the knob to the unlocked state during the switching process from the locked state to the unlocked state, thereby improving the locking safety. Therefore, while improving the feel of turning operation, it also guarantees the locking safety, and the battery is not easy to fall out of the body. Especially, for the battery and the UAV body, during the flight of the UAV, the battery can be stably connected to the UAV body to ensure stable power supply and reduce the accident rate of the UAV. In addition, the in-position detection device detects the position of the locking assembly to realize the self-detection of the battery unlocking knob before the unmanned aerial vehicle takes off, thereby preventing the take-off when the battery is not locked. This improves the safety of the UAV.

Generally, in order to improve the reliability of machine operation, the machine can be equipped with two or more batteries, so that at least one battery can be used as a backup battery to prevent the battery from running out or malfunctioning. When the battery is supplying power, the battery needs to be locked by a locking assembly to ensure the stability of the electrical connection of the battery. In one embodiment, there are at least two batteries 200. As shown in FIGS. 5 and 6, taking two batteries 200 as an example for description, the body 100 may have two accommodating cavities X arranged side by side. Each accommodating cavity X is provided with a battery 200 correspondingly. The two accommodating cavities X can be separated by a middle side wall X1. The locking assembly 300 can be arranged on the middle side wall X1, and preferably, is located on the middle part of the middle side wall X1. This can ensure maximum balance of forces on the two batteries 200.

Optionally, as shown in FIG. 6, the knob 10 may include support arms 11, which are used to press against the battery 200. The number of the support arms 11 may be equal to the number of the batteries 200. Each support arm 11 correspondingly presses against a battery 200.

The at least two batteries 200 can be evenly arranged, and the knob 10 can be located in the middle position enclosed by the at least two batteries 200. The included angle between every two adjacent batteries 200 may be equal to the included angle between every two adjacent arms 11 of the knob. Specifically, for example, there may be two batteries 200, and the knob 10 may have two arms 11. The two batteries 200 are arranged side by side, and the included angle between the two arms 11 of the knob 10 is approximately 180°.

Optionally, when the knob 10 is switched between the locked state and the unlocked state, the angle rotated by the knob 10 is approximately 90°.

Of course, it can be understood that taking FIGS. 5 and 6 as an example, in positions other than the unlocked state, before the knob 10 reaches the horizontal position, the locking assembly 300 is in the intermediate locked state. In this intermediate locked state, the battery 20 cannot be removed from the accommodating cavity X.

Optionally, the pushing device 20 is movably arranged between the knob 10 and the body 100. The pushing device 20 may be provided between the knob 10 and the body 100 through a detachable member. The pushing device 20 is used to apply an elastic pressing force in a direction away from the body 100 to the knob 10 during the rotation of the knob 10.

As shown in FIG. 8, the pushing device 20 may have a guiding surface 221, and the knob 10 may have a mating surface (not shown in the figure). During the rotation of the knob 10, the guiding surface 221 cooperates with the mating surface to push against the pushing device 20 while the knob 10 rotates. Optionally, the guiding surface 221 may be an arc surface or an inclined surface.

In one embodiment, as shown in FIGS. 5, 6 and 8, the pushing device 20 has a first contact surface 22a and a second contact surface 22b. The guiding surface 221 is connected between the first contact surface 22a and the second contact surface 22b. In the unlocked state, the lower surface of the knob 10 contacts the first contact surface 22a, and in the locked state, the lower surface of the knob 10 contacts the second contact surface 22b. The first contact surface 22a is higher than the second contact surface 22b.

In addition, the pushing device 20 may have inserting posts 23 for inserting into the body 100. During the movement of the pushing device 20, the position of the inserting post 23 in the body 100 changes. In this way, an in-position detection device 50 for detecting the position of the inserting post 23 can be provided in the body 100 to determine the state of the locking assembly. A waterproof sealing ring 24 may be sleeved on the inserting post 23. The waterproof sealing ring 24 may be located between the pushing device 20 and the detachable member 40. The inserting post 23 of the pushing device 20 may slide in the waterproofing ring 24, and thus does not affect the waterproof performance of the UAV itself.

Optionally, as shown in FIG. 3, in the unlocked state, the end of the inserting post 23 is in contact with the in-position detection device 50. As shown in FIG. 4, in the locked state, the end of the inserting post 23 is not in contact with the in-position detection device 50. Alternatively, in the unlocked state, the end of the inserting post 23 does not contact the in-position detection device 50, and in the locked state, the end of the inserting post 23 contacts the in-position detection device 50.

In some embodiments, the in-position detection device 50 can also determine the state of the locking assembly by measuring the height of the inserting post 23, for example, by a distance sensor, which is not described in detail in this embodiment.

Optionally, the body 100 of this embodiment is also provided with a prompting device (not shown in the figure), which is electrically connected to the in-position detection device 50. The prompting device is used for sending out prompting information when the in-position detection device 50 detects that the inserting post 23 is at the preset position. The prompt information sent by the prompting device may be any one of information such as voice, light, or text.

In this embodiment, in the process of switching from the locked state to the unlocked state, the knob 10 can push the pushing device 20 to move closer to the body 100, and the pressing force exerted by the pushing device 20 on the knob 10 gradually increases.

In the process of switching from the unlocked state to the locked state, the pushing device 20 moves away from the body 100, and the pressing force exerted by the pushing device 20 on the knob 10 gradually decreases.

As shown in FIGS. 1, 2 and 7, the pushing device 20 can include a floating block 21 and an elastic member 22. The floating block 21 can be used to push the knob 10, and the elastic member 22 may be provided between the floating block 21 and the body 100. In the process of switching from the locked state to the unlocked state, the elastic member 22 is gradually compressed. In the process of switching from the unlocked state to the locked state, the elastic member 22 gradually recovers from deformation.

In some embodiments, the knob 10 and the pushing device 20 may be coaxially connected by a connecting shaft 30. One end of the connecting shaft 30 passes through the knob 10 and the abutting device 20 to be fixedly connected to the body 100. The other end of the connecting shaft 30 has an axial limiting member 31 for axially limiting the positions of the knob 10 and the pushing device 20.

Optionally, the connecting shaft 30 may be a screw, and the nut of the screw may form the axial limiting member 31.

Optionally, as shown in FIGS. 1 and 2, a first lubricating device 30a may be sleeved on the connecting shaft 30. In the axial direction of the connecting shaft 30, the first lubricating device 30a may be located between the axial limiting member 31 and the knob 10. The first lubricating device 30a may be used to reduce the friction coefficient between the knob 10 and the axial limiting member 31 when the knob 10 rotates. Wherein, the first lubricating device 30a may include at least one of the following: a Teflon sheet, a copper sleeve, or a thrust bearing (not shown in the figure).

Similarly, a second lubricating device 30b can be sleeved on the connecting shaft 30. In the axial direction of the connecting shaft 30, the second lubricating device 30b is located between the knob 10 and the body 100. The second lubricating device 30b may be used to reduce the friction coefficient between the knob 10 and the body 100 when the knob 10 is rotated. Wherein, the second lubricating device 30b may include at least one of the following: a Teflon sheet, a copper sleeve, or a thrust bearing (not shown in the figure).

On the premise of no conflict, the specific structure and specific functions of the locking assembly in the movable platform provided in these embodiments except the in-position detection device are the same as those in the above embodiment. For details, please refer to the description of the above embodiment, which will not be repeated here.

In several embodiments provided by the present disclosure, the mutual coupling or communication connection may be indirect coupling or communication connection through some interfaces, devices or units, and may be in electrical or mechanical or other forms.

The principles and the embodiments of the present disclosure are set forth in the specification. The description of the embodiments of the present disclosure is only used to help understand the apparatus and method of the present disclosure and the core idea thereof. Meanwhile, for a person of ordinary skill in the art, the disclosure relates to the scope of the disclosure, and the technical scheme is not limited to the specific combination of the technical features, but also covers other technical schemes which are formed by combining the technical features or the equivalent features of the technical features without departing from the inventive concept. For example, a technical scheme may be obtained by replacing the features described above as disclosed in this disclosure (but not limited to) with similar features.

What is claimed is:

1. A locking assembly for locking at least one second body to a first body, the first body having at least one accommodating cavity for accommodating the at least one second body respectively, comprising:
a knob configured to be on the first body; and
a pushing device between the knob and the first body,
wherein the knob is configured to rotate around an axis to switch the locking assembly between a locked state and an unlocked state; and
the pushing device is configured to apply an elastic pressing force on the knob in a direction away from the first body during rotation of the knob.

2. The locking assembly of claim 1, wherein in the locked state, the knob pushes and fixes the at least one second body in the at least one accommodating cavity respectively, and in the unlocked state, the knob avoids the at least one second body.

3. The locking assembly of claim 1, wherein in a process of switching from the locked state to the unlocked state, the knob rotates to drive the pushing device to move in a direction toward the first body, and the elastic pressing force applied by the pushing device on the knob increases.

4. The locking assembly of claim 3, wherein in a process of switching from the unlocked state to the locked state, the pushing device moves in a direction away from the first body, and the elastic pressing force applied by the pushing device on the knob decreases.

5. The locking assembly of claim 4, wherein the pushing device comprises a guiding surface, the knob comprises a mating surface, and the guiding surface is configured to cooperate with the mating surface to drive the pushing device to move during the rotation of the knob.

6. The locking assembly of claim 5, wherein the guiding surface is an arc surface or an inclined surface.

7. The locking assembly of claim 5, wherein the pushing device has a first contact surface and a second contact surface, and the guiding surface is connected between the first contact surface and the second contact surface;
in the unlocked state, a lower surface of the knob is in contact with the first contact surface, and in the locked state, the lower surface of the knob is in contact with the second contact surface; and
the first contact surface is higher than the second contact surface.

8. The locking assembly of claim 1, wherein the pushing device comprises a floating block and an elastic member, the floating block is configured to push the knob, and the elastic member is between the floating block and the first body, in a process of switching from the locked state to the unlocked state, the elastic member is gradually compressed; and in a process of switching from the unlocked state to the locked state, the elastic member gradually recovers from compressed deformation.

9. The locking assembly of claim 1, wherein the knob and the pushing device are coaxially connected by a connecting shaft.

10. The locking assembly of claim 9, wherein one end of the connecting shaft passes through the knob and the pushing device to be fixedly connected to the first body, and the other end of the connecting shaft is provided with an axial limiting member for axially limiting positions of the knob and the pushing device.

11. The locking assembly of claim 1, wherein there are at least two second bodies.

12. The locking assembly of claim 11, wherein the knob comprises at least one support arm, the number of support arms is equal to the number of the second bodies, and one of the support arms presses against one of the second bodies correspondingly.

13. The locking assembly of claim 12, wherein the at least two second bodies are evenly arranged around the knob, and an included angle between every two adjacent second bodies is approximately equal to an included angle between every two adjacent support arms of the knob.

14. The locking assembly of claim 1, wherein the pushing device comprises an inserting post for inserting into the first body and an in-position detection device,
wherein the in-position detection device is configured to detect an end position of the inserting post in the first body or a height of the inserting post from the first body so as to determine the state of the locking assembly.

15. The locking assembly of claim 1, wherein the first body is a body of a movable platform, and the second body is a battery.

16. The locking assembly of claim 15, wherein the movable platform is an unmanned aerial vehicle.

17. A locking assembly for locking at least one second body on a first body, the first body having at least one accommodating cavity for accommodating the at least one second body respectively, comprising:
a detachable member detachably fixed with the first body
a knob provided on the first body through the detachable member, the knob capable of rotating around an axis relative to the first body,
wherein the knob is configured to rotate to switch the locking assembly between a locked state and an unlocked state, in the locked state, the knob pushes and fixes the at least one second body in the at least one accommodating cavity respectively, and in the unlocked state, the knob avoids the at least one second body.

18. The locking assembly of claim 17, further comprising:
a pushing device movably arranged between the knob and the detachable member, wherein the pushing device is configured to apply an elastic pressing force on the knob in a direction away from the first body during rotation of the knob.

19. The locking assembly of claim 18, wherein in a process of switching from the locked state to the unlocked state, the knob rotates to drive the pushing device to move in a direction toward the first body, and the elastic pressing force applied by the pushing device on the knob gradually increases.

20. A movable platform, comprising a body, at least one battery, and a locking assembly for locking the at least one battery on the body, the body having at least one accommodating cavity for accommodating the at least one battery respectively; the locking assembly comprising:
a knob on the body, the knob capable of rotating around an axis relative to the body; and
a pushing device movably arranged between the knob and the body,
wherein the pushing device is configured to apply an elastic pressing force on the knob in a direction away from the body during rotation of the knob; and
the knob is configured to rotate to switch the locking assembly between a locked state and an unlocked state, wherein in the locked state, the knob pushes and fixes the at least one battery in the at least one accommodating cavity respectively, and in the unlocked state, the knob avoids the at least one battery.
